(19) United States
(12) Patent Application Publication
(10) Pub. No.: US 2014/0266255 A1
(43) Pub. Date: Sep. 18, 2014

(54) AUTOMATED PROFILING OF THE DIELECTRIC BEHAVIOR OF WOOD

(71) Applicant: OSMOSE UTILITITES SERVICES, INC., Buffalo, NY (US)

(72) Inventor: Randal K. More, LaFayette, NY (US)

(73) Assignee: Osmose Utilitites Services, Inc., Buffalo, NY (US)

(21) Appl. No.: 13/828,303

(22) Filed: Mar. 14, 2013

(51) Int. Cl. G01N 27/22

(52) U.S. Cl. CPC G01N 27/221
USPC 324/679; 324/658

(57) ABSTRACT

A device for evaluating the internal dielectric behavior of a structure with a capacitive sensor and a method of using such a device. The device allows a user to measure the internal dielectric behavior of a wooden structure and to derive a density profile for that structure from the determined dielectric behavior. The condition profile allows the user of the device to locate regions of altered condition within a structure to determine whether that structure has suffered from internal decay, pre-rot, rot, or other forms of damage. The minimally-invasive device avoids the need for more damaging and destructive modes of analysis of the wooden structure and is able to provide accurate and repeatable measurements of the structure's density and moisture content, obviating the need for more complex and expensive equipment and techniques.

### TECHNICAL FIELD

The present invention pertains to a device and method for evaluating the condition of wood by automated profiling of the dielectric behavior of a structure and in particular a wooden structure. More particularly, the present invention is directed towards a handheld device comprising a capacitive sensor for measuring the dielectric behavior of wood in a wooden structure, a method for operating such a device and determining the condition of wood by identifying the dielectric behavior and changes in the dielectric behavior areas of irregular density or moisture content in a wooden structure from the recorded capacitive measurements.

### BACKGROUND OF THE INVENTION

The regular inspection of wooden structures such as utility poles, support pilings, and other timber structures is an essential part of the maintenance and upkeep of such structures. Aging wood can suffer from internal decay and/or rot as a result of insect and fungal infestations as well as the presence of excessive moisture in the wood, and can develop voids, cracks, and cavities in its structure. Such flaws in the structural integrity of a utility pole or other wooden structure can lead to a loss of strength in the structure, decreasing the load that can be borne by the structure and in some cases necessitating restoration or even replacement. Therefore, accurate methods of assessing the condition of wooden structures are required to minimize the risks associated with the aging of these structures.

The most basic method of inspecting a wooden structure is a visual inspection, in which trained personnel inspect the exterior of a utility pole or other wooden structure looking for structural deficiencies such as visible cracks, fissures, and splits in the surface of the structure, plant life or algae growing on the wood, and holes bored by woodpeckers or insects. While this technique is the most simple method of structural analysis, it is also the most limited in quality. A purely visual inspection of a wooden structure will fail to locate any internal decay, deficiencies or changes in the conditions of a structure. Visual inspection, alone, can produce variable results that depend on the experience and the diligence of the particular inspector.

In addition to purely visual methods, other non-invasive methods of analyzing the structural integrity of wooden structures have also been developed, such as the use of micro-power impulse radar and penetrating radar, reflective and sound velocity sonar, and electrical propagation analysis. However, these more complex techniques require the use of extremely expensive and fragile equipment operated by highly-trained personnel, making them impracticable for use in the vast majority of wooden structure inspections. Moreover, many of these complex techniques are unable to analyze the condition of wooden structures (such as, for example, utility poles) below the ground line, where moisture is more likely to penetrate the structure, wood conditions are more susceptible to change and where decay and rot are more likely to occur.

Efforts to obtain structural profiles of wood with greater accuracy than those resulting from purely visual inspections, while at the same time avoiding the equipment and personnel requirements of the complex non-invasive methods, have resulted in the development of minimally destructive analysis techniques for the inspection of wooden structures. “Sound and prod” and “sound and bore” techniques involve inspection personnel “sounding” the structure by striking it with a hammer, spike, or other instrument and listening to the resulting sound for hollow-sounding noises or other audible indications of internal deficiencies. Next, the inspection personnel engage in “prodding” or “probing” the pole by inserting a screwdriver, drill, or other boring tool to sample the interior of the pole or other structure in a search for decay or damage. Personnel may also scrape the exterior of the wood to examine the structure for surface decay.

While more rigorous than purely visual inspections, the accuracy of these manual minimally invasive techniques, much like visual inspections, are highly dependent on the skill and expertise of the particular personnel inspecting the structures. Results will often not be repeatable or standardized between different practitioners inspecting poles of similar quality. Additionally, it is common for utility poles and other structures to “deceive” inspectors using these manual methods—the accuracy of these methods in locating decay or damage is entirely dependent on the inspector having the good fortune to sound and/or probe the pole in exactly the right location to find the structural problem. If the inspector happens to bore a hole through healthy wood that is mere inches away from a decayed portion of the structure, he or she may come to a seriously flawed conclusion as to the structural integrity of the wood.

As discussed above, existing devices and methods for inspecting wooden structures for internal damage or decay suffer from many deficiencies. Existing non-invasive methods of evaluating the internal integrity of a wooden structure are either insufficiently rigorous to provide an accurate structural profile (purely visual inspections) or require overly expensive and delicate equipment that must be operated by highly trained personnel. Existing minimally-invasive inspection methods are either highly variable and dependent upon the quality of the personnel conduction the inspection (manual “sound and bore” methods) or require expensive specialized equipment (Resistograph®). Moreover, all existing minimally-invasive methods suffer from only being able to detect structural deficiencies in the specific material of the structure which was bored through.

As a result, there is a need for minimally-invasive techniques which allow inspection personnel to perform repeatable, standardized and accurate inspections of utility poles and other wooden structures and that do not require the use of complex, expensive equipment. Additionally, such minimally invasive techniques should not be limited to evaluating merely the material bored through by the inspection personnel, but should be capable of analyzing the structural integrity of the surrounding wood of the utility pole or other wooden structure as well. The devices and methods of the present invention, which are described in detail below, solve the need in the art for such techniques.

### SUMMARY OF THE INVENTION

The present invention provides a device for evaluating the dielectric behavior of a structure. A device for evaluating the dielectric behavior of a structure comprises a distance sensor, a shaft and a capacitive sensor. In one aspect, the device comprises a capacitive sensor mounted to a shaft. In another aspect, the device comprises a distance sensor mounted on a shaft. The distance sensor may be any device that allows the determination of the location of the capacitive sensor in the wood. The distance sensor includes but is not limited to mechanical, electrical, optical and sound-based sensors, and the like. In a preferred aspect, the distance sensor is a short-range sonar. In another aspect, the device is handheld and in yet another aspect the device further comprises a handle.

The shaft component of the present invention is preferably electrically non-conductive. Examples of non-conductive material suitable for use as a shaft include but are not limited to polyester, fiberglass, polyester impregnated with fiberglass, and the like.

In one aspect of the present invention, the capacitive sensor is located on the tip of the shaft. In another aspect, the shaft and capacitive sensor are sized so that said shaft and sensor may be inserted into an opening into a structure. In one aspect, the shaft and capacitive sensor have a diameter between ¼ and ½ inches. In a preferred aspect, the capacitive sensor and shaft has a diameter of about ⅜ inch. In one aspect, the capacitive sensor has a length between 0.5 and 1 inches.

In one aspect of the invention, the capacitive sensor further comprises a capacitive sensor plate. In another aspect of the invention, the capacitive sensor plate comprises a concentric ring. In yet another aspect of the invention, the capacitive sensor plate comprises a broken concentric ring. In another aspect of the invention, the device is electrically grounded by an operator of the device or the structure.

The device of the present invention may be used in methods of assessing the condition or dielectric behavior of a structure. In one aspect of the invention, the device of the present invention is introduced into a hole produced in the structure.

In another aspect, the present invention provides a method for evaluating the dielectric behavior or condition of a structure, comprising the steps of inserting a capacitive sensor into a structure; determining a location of the capacitive sensor in the structure with a distance sensor; measuring the discharge rate of the capacitive sensor in said structure; and moving the capacitive sensor deeper into the structure while continuing to determine the location within the structure and measuring the discharge rate of the capacitive sensor. The capacitive discharge rate of the capacitive sensor in a particular material correlates to the dielectric behavior of that material.

As used herein, the term “structure” refers to any structure comprising any dielectric material. In one aspect of the invention the device of the present invention may be used in methods to assess the dielectric behavior or produce a profile of a structure comprising wood. Specifically, a structure comprising wood includes but is not limited to wood composites, timber, boards, lumber, pilings, beams, utility poles, and the like.

The methods of the present invention comprise the step of measuring the discharge rate of a capacitive sensor, which is indicative of the dielectric behavior of the wood surrounding the capacitive sensor at a location within the structure. The dielectric behavior of a structure is indicative of the condition of the wood at a location within the structure. In one aspect of the present invention, the method of the present invention further comprises the step of comparing the dielectric behavior of the wood surrounding the capacitive sensor at a location within the structure with the dielectric behavior of reference wood. As used herein, “reference wood” means wood in the condition of a wood structure when that wood structure is first placed into service or a portion of the wood structure identified by inspection or other means to be intact, without damage, decay, defects or elevated moisture levels. For example, a portion of the structure under evaluation may serve as the “reference wood.” In practice, an inspector or operator will select a portion of the wood structure that appears intact by visual inspection, probing or other means. The identified portion is then analyzed to determine the dielectric behavior of the reference wood.

By way of example, when a wood structure is first placed into service, the condition of the wood therein is essentially homogenous. As used herein, “condition” refers to the state of a structure relative to “reference wood.” Different states of a structure relative to reference wood include but are not limited to intact, dried wood, such as the type of wood present in a wood structure when said structure is first placed into service, wood with elevated moisture content, which is one indication of pre-decay, decayed wood, damaged wood (including but not limited to mechanical damage), and the like. Changes in the dielectric behavior of wood within a wood structure is indicative of a change in the condition of the wood within the structure. When the dielectric behavior of the wood surrounding the capacitive sensor is essentially the same as the dielectric behavior of the reference wood, the condition of the evaluated wood is considered “normal.” As used herein, “normal” or “normal wood” refers to wood that displays essentially the same dielectric properties as a reference wood. “Normal wood” has the same condition as “reference wood.” When the dielectric behavior of the wood surrounding the capacitive sensor is different (not essentially the same) than “reference wood,” the condition of the evaluated wood is considered “decayed,” “damaged” or “altered.”

The present invention provides a device and a method for assessing the condition of a wood structure that surrounds the capacitive sensor and is not limited to the wood immediately adjacent to the capacitive sensor. In one aspect of the invention, the wood surrounding the capacitive sensor comprises the wood within 5, 10, 15, 20, 25, 30, 35, 40, 45, 50, 60, 70, 80, 90 and 100 millimeters of the capacitive sensor. The wood surrounding the capacitive sensor in the structure may be exposed by any conventional means, including, but not limited to drilling or boring a hole. In one aspect of the invention, the hole has a diameter of no greater than ¼, ⅜, ½ or ¾ inches.

The present invention also provides a method of profiling a wood structure comprising the steps of determining the dielectric behavior of wood at a plurality of locations within the wood structure; determining the location of each determined dielectric behavior within the wood structure; and comparing the dielectric behavior at a plurality of locations within the wood structure to a dielectric behavior of a reference wood to prepare a profile of the condition of the wood structure.

The present invention also provides methods for determining the capacity remaining in a structure or determining whether a structure is suitable for a particular load. In one aspect of the invention, said methods comprise the steps of determining the dielectric behavior of wood at a plurality of locations within the wood structure; determining the location of each determined dielectric behavior within the wood structure; comparing the dielectric behavior at a plurality of locations within the wood structure to a dielectric behavior of a reference wood to prepare a profile of the condition of the wood structure; and utilizing the profile of the condition of the wood structure to estimate the remaining strength of the wood structure.

The present invention also provides methods for identifying structures for remedial treatment or reinforcement comprising the steps of determining the dielectric behavior of wood at a plurality of locations within the wood structure; determining the location of each determined dielectric behavior within the wood structure; comparing the dielectric behavior at a plurality of locations within the wood structure to a dielectric behavior of a reference wood to prepare a profile of the condition of the wood structure; and utilizing the profile of the condition of the wood structure to determine whether the wooden structure should be rehabilitated.

The present invention also provides methods for the regular inspection and maintenance of in-place wooden structures comprising the steps of selecting a wood structure as a representative wooden structure; determining the dielectric behavior of wood at a plurality of locations within the wood structure; determining the location of each determined dielectric behavior within the wood structure; and comparing the dielectric behavior at a plurality of locations within the wood structure to a dielectric behavior of a reference wood to prepare a profile of the condition of the wood structure.

The present invention also provides methods for the planning of future inspection and maintenance actions of in-place wooden structures comprising the steps of determining the dielectric behavior of wood at a plurality of locations within the wood structure; determining the location of each determined dielectric behavior within the wood structure; comparing the dielectric behavior at a plurality of locations within the wood structure to a dielectric behavior of a reference wood to prepare a profile of the condition of the wood structure; and determining whether to accelerate or decelerate a schedule for future inspection and maintenance actions for the wood structure based on the profile of the condition of the wood structure.

The present invention also provides methods for identifying a serviceable in-place wooden structure comprising the steps of determining the dielectric behavior of wood at a plurality of locations within the wood structure; determining the location of each determined dielectric behavior within the wood structure; comparing the dielectric behavior at a plurality of locations within the wood structure to a dielectric behavior of a reference wood to prepare a profile of the condition of the wood structure; and applying at least one remedial treatment selected from the group consisting of an external preservative, a liquid internal preservative, a solid internal preservative, and a fumigant, to the wood structure.

The present invention also provides methods for identifying a reinforceable reject in-place wooden structure comprising the steps of determining the dielectric behavior of wood at a plurality of locations within the wood structure; determining the location of each determined dielectric behavior within the wood structure; comparing the dielectric behavior at a plurality of locations within the wood structure to a dielectric behavior of a reference wood to prepare a profile of the condition of the wood structure; and reinforcing the wood structure by splinting or stubbing the wood structure with at least one of steel channel, fiberglass, and epoxy.

The present invention also provides methods for identifying a replacement candidate in-place wooden structure comprising the steps of determining the dielectric behavior of wood at a plurality of locations within the wood structure; determining the location of each determined dielectric behavior within the wood structure; comparing the dielectric behavior at a plurality of locations within the wood structure to a dielectric behavior of a reference wood to prepare a profile of the condition of the wood structure; and replacing the wood structure with a structure having a sufficient level of strength.

The present invention also provides methods for identifying a priority reject in-place wooden structure comprising the steps of determining the dielectric behavior of wood at a plurality of locations within the wood structure; determining the location of each determined dielectric behavior within the wood structure; comparing the dielectric behavior at a plurality of locations within the wood structure to a dielectric behavior of a reference wood to prepare a profile of the condition of the wood structure; utilizing the profile of the condition of the wood structure to identify decay or damage in the wood structure; and removing the wood structure from service.

### BRIEF DESCRIPTION OF THE DRAWINGS

FIG. 1 depicts a side view of an exemplary device of the present invention.

### DETAILED DESCRIPTION OF THE INVENTION

Changes in the dielectric behavior of a structure are indicative of the condition of that structure. Dielectric properties of a material, such as wood, generally include dielectric constant, dielectric loss, loss factor, power factor, AC conductivity, DC conductivity, electrical breakdown strength and other equivalent or similar properties. As used herein, the term “dielectric behavior” refers to the variation of dielectric properties with frequency, temperature, voltage, density, and composition, including but not limited to water or moisture content. For example, decay and decomposition of a wooden structure alters the structure of the wood and changes the density of the structure, as compared to intact wood (for example, no decay and decomposition or mechanical damage), which alters the dielectric behavior of the wood. Moisture penetration into a wood structure (one indicator of pre-decay), also alters the dielectric behavior of the wood structure, compared to a dry reference.

The present invention provides a device for evaluating the dielectric behavior of a structure. A device for evaluating the dielectric behavior of a structure comprises a distance sensor, a shaft and a capacitive sensor. In one aspect, the device comprises a capacitive sensor mounted to a shaft. In another aspect, the device comprises a distance sensor mounted on a shaft.

The distance sensor may be any device that allows the determination of the location of the capacitive sensor in the wood. The distance sensor includes but is not limited to mechanical, electrical, optical and acoustical sensors, and the like. In a preferred aspect, the distance sensor is a short-range sonar. In another aspect, the device is handheld and in yet another aspect the device further comprises a handle.

Capacitive sensors suitable for use in the present invention are known in the art and are commercially available. Capacitive sensors may be constructed from many different media, such as copper, Indium tin oxide (ITO) and printed ink. Copper capacitive sensors can be implemented on standard FR4 PCBs as well as on flexible material. In one aspect of the invention, the capacitive sensor is folded, wound, or otherwise manipulated to allow the capacitive sensor to be inserted into a structure and more preferably into an opening into the structure with a diameter of about ⅛, ¼, ⅜ or ½ inches. In another aspect of the present invention, the capacitive sensor is in the form of cylindrical thread or the like. In yet another aspect of the invention, the capacitive sensor further comprises a shield or shielding.

The shaft component of the present invention is preferably electrically non-conductive. Examples of non-conductive material suitable for use as a shaft include but are not limited to polyester, fiberglass, polyester impregnated with fiberglass, and the like.

In one aspect of the present invention, the capacitive sensor is located on the tip of the shaft. In another aspect, the shaft and capacitive sensor are sized so that said shaft and sensor may be inserted into an opening into a structure. In one aspect, the shaft and capacitive sensor have a diameter between ¼ and ½ inches. In a preferred aspect, the capacitive sensor and shaft has a diameter of about ⅜ inch. In one aspect, the capacitive sensor has a length between 0.5 and 1 inches.

FIG. 1 depicts an exemplary device 100 for automatically profiling the density, and therefore the strength, of a structure 110. In an exemplary aspect, the device 100 comprises a handle 102, a distance sensor 104, a shaft 106, and a capacitive sensor 108. In certain aspects of the invention, the device 100 is operated by inserting the capacitive sensor 108 into a hole 112 in the structure 110. The capacitive sensor 108 determines the dielectric behavior (and therefore the relative density) of the material of the structure 110 surrounding the sensor 108.

In certain aspects of the present invention, as the capacitive sensor 108 is moved forward, deeper into the structure 110, the distance sensor 104 determines the distance to the structure 110 and therefore how deep the capacitive sensor 108 is located within the structure 110, and this depth value is recorded along with the dielectric behavior of the surrounding material at that depth, as determined by the discharge rate of the capacitive sensor 108. In aspects of the invention, the recorded depth and dielectric values may be normalized and integrated to create a density profile for the material of the structure 110.

In certain aspects of the invention, the structure 110 to be inspected is comprised of wood. In certain exemplary aspects, the structure 110 can consist of a utility pole, a piling, a beam, a board, a timber, or any other type of wooden structure. The structure 110 can consist of Western red cedar, Douglas-fir, southern pine, lodgepole pine, or any other species of wood suitable for use in constructing the structure 110.

The density of wood has a consistent effect on the dielectric constant \acute{∈} of the wood, causing the dielectric constant of the wood to increase with increasing density. As a result, regions of the structure 110's wood that suffer from decay/damage or contain defects such as cracks, knots, or cavities, having a different density than the sound wood of the structure 110, will have a detectably different dielectric constant than that of the sound wood. The device 100, which records the dielectric behavior of the surrounding wood, can therefore detect decay or defects in the structure 110 without actually coming into physical contact with those defective regions.

Additionally, the dielectric constant \acute{∈} of wood also increases as the moisture content of that wood increases. There is a roughly linear relationship between the moisture content of wood and the logarithm of the dielectric constant of that wood. As a result, regions of a structure 110's wood that contain excessive moisture, such as particular tree rings within a utility pole or other timber structure, will have a detectably different dielectric constant than that of the sound wood of structure 110. Areas of high moisture can serve as an possible indicator of decay/rot, and device 100 is able to detect such areas within the structure 110 without coming into physical contact with those areas.

In certain aspects of the invention, the distance sensor 102 for recording the depth of the capacitive sensor 108 in the structure 110 is mounted on the handle 102 of the device 100. In aspects of the present invention, the distance sensor 102 can consist of, for example, a short-range sonar, a laser, a short-range radar, or any other type of non-contact or contact distance sensor 102. In certain aspects, the distance sensor 102 is a short-range sonar which transmits a pulse of sound (also known as a “ping”) from an acoustical transmit/receive array or an external transducer. The ping reflects off the surface of the structure 110 and is received by the short-range sonar distance sensor 102. The distance sensor 102 then uses the speed of the transmitted ping and the elapsed time between the transmission and receipt of the ping to calculate the distance between the sensor 102 and the face of the structure 110. In aspects of the invention, the short-range sonar distance sensor 102 can be oriented from about a 45 degree angle to about a 90 degree angle from the face of the structure 110 while still receiving a sufficient return signal from the transmitted ping to provide the sensor 102 with an accurate distance reading.

In certain aspects of the present invention, the capacitive sensor 108 is mounted on the shaft 106 of the device 100. The shaft 106 is comprised of a material having an appropriate dielectric constant for the capacitive sensor 108. In aspects of the invention, the shaft 106 may be comprised of a composite material consisting of fiberglass embedded in a synthetic polymer, including but not limited to polyesters, phenol-formaldehydes, epoxies, silicones, polyimides, aliphatic polyamides, polycarbonates, as well as other fiber-reinforced plastics. In aspects of the invention, the dielectric constant of such fiber-reinforced plastics varies from about 4 to about 14.

In certain aspects of the invention, the device 100 is grounded. In aspects of the invention, the device 100 is grounded to the operator. In other aspects, the device 100 is grounded to the structure 110.

In certain aspects of the present invention, the capacitive sensor 108 is mounted on the tip of the shaft 106. The capacitive sensor 108 may be a radial capacitive sensor or an axial capacitive sensor. In some aspects, the capacitive sensor 108 is comprised of a capacitive plate to which a voltage is applied. In certain aspects of the invention, the capacitive plate of the capacitive sensor 108 is a concentric ring. In various aspects of the invention, the concentric ring may be an unbroken or a broken ring.

The voltage applied to the sensor tip establishes an electric field between the capacitive sensor 108 and the surrounding wood. By measuring the discharge rate of the capacitive sensor 108, the dielectric behavior of the surrounding wood of a structure 110, and therefore the density and moisture content of that surrounding wood, can be determined and recorded. In aspects of the invention, the capacitive sensor 108 can determine the dielectric behavior of the wood surrounding the sensor 108 to a depth of about 0.2 mm, 0.25 mm, 0.3 mm, 0.4 mm, 0.5 mm, or 0.75 mm into the surrounding wood.

In aspects of the present invention, the capacitive sensor 108 may be about ½ inches, about ⅜ inches, about ¼ inches, or about ⅛ inches in diameter. Additionally, the capacitive sensor 108 may be about ½ inches, about ⅝ inches, about ¾ inches, about ⅞ inches, or about 1 inch in length. Increasing the size of capacitive sensor 108 increases the area of the surrounding wood whose dielectric behavior are measured by sensor 108. However, this increase in the size of the sensor 108 also decreases the resolution of sensor 108.

In aspects of the invention, the capacitive sensor 108 includes a guard ring and a cable shield. The guard ring creates an additional electric field around the capacitive sensor plate and is driven at the same phase and voltage potential as the capacitive sensor plate. This auxiliary guard field protects the electric field of the capacitive sensor plate from becoming warped and cancels out any stray capacitance. In certain aspects, the width of the guard ring is at least twice the measurement range of the capacitive sensor 108.

In aspects of the invention, the capacitive sensor 108 also comprises a cable shield to reduce noise and external interference. The capacitive sensor 108 is driven by a low-noise co-axial cable, and the shield of the cable is used to deliver voltage to the guard at the same voltage potential and phase as the capacitive sensor plate. The voltage delivered to the guard via the cable shield serves to eliminate any stray capacitance that might be created between the center conductor and the shield of the cable, and significantly reduces external influences from electromagnetic interference and radio frequency interference, such as from overhead transmission lines or equipment, for example.

In aspects of the invention, the capacitive sensor 108 is inserted into a hole 112 in a structure 110 in order to gather data about the internal density of that structure 110. The hole 112 may be pre-drilled, or may be bored or drilled by the personnel conducting the inspection of the structure 110, by using a drill or a borer, for example. In some aspects of the invention, the sensor 108 is inserted into a pre-drilled hole 112 to avoid drilling new holes that may further compromising the integrity of the structure 110. In other aspects of the invention, the personnel conducting the inspection of the structure 110 may choose to drill or bore a new hole 112 in structure 110 to ensure that the wood surrounding the entrance of hole 112 is healthy, non-decayed wood that provides an accurate dielectric constant “baseline” for the capacitive sensor 108's measurements. In these aspects, the personnel may penetrate the exterior of the wooden structure 110 with the drill or bore above the ground line of wooden structure 110, and then angle the drill or bore downwards so that at least a portion of the inspection hole 112 in the interior of structure 110 is located below the ground line of structure 110, which is a prime location for decay. In aspects of the invention, the inspection hole 112 may be from about ⅛ inches, about ¼ inches, about ⅜ inches, or about ½ inches in diameter.

In some aspects of the invention, once measurements have been collected and recorded by the distance sensor 104 and the capacitive sensor 108, the discharge rate measured by capacitive sensor 108 is plotted against the corresponding distances recorded by distance sensor 104. The plot provides a visualization of the dielectric behavior of a cross-section of the wood of the structure 110. The visualization allows personnel to identify areas within the structure 110 with anomalous dielectric constant values, which can be an indication that those areas have a low density or contain excessive moisture. In some aspects of the invention, these measured distance and discharge rate values are normalized by performing signal processing operations on the measurements, which are then integrated to form a profile for the dielectric constants of the wood of structure 110, which can be analyzed to locate anomalies in the wood as discussed above.

The present invention also provides a method of evaluating the dielectric behavior of a structure by using such a device. One aspect of the invention is a device for evaluating the dielectric behavior of a structure, comprising a distance sensor, a shaft, and a capacitive sensor. Another aspect of the invention is a method for evaluating the density of a structure, comprising the steps of inserting a capacitive sensor into a structure to measure the depth of the capacitive sensor in the structure, measuring the discharge rate of the capacitive sensor, and moving the capacitive sensor deeper into the structure while continuing to measure the depth and the discharge rate of the capacitive sensor. The capacitive discharge rate of the capacitive sensor in a particular material correlates to the dielectric behavior of that material.

The present invention also provides a method of profiling a wood structure comprising the steps of determining the dielectric behavior of wood at a plurality of locations within the wood structure; determining the location of each determined dielectric behavior within the wood structure; and comparing the dielectric behavior at a plurality of locations within the wood structure to a dielectric behavior of a reference wood to prepare a profile of the condition of the wood structure.

### Inspection of Utility Structures

Regular inspection and maintenance of in-place wooden structures, such as wooden poles, is essential to extending the useful life of these structures by ensuring that their wood retains its strength. A comprehensive maintenance program for wooden utility poles, for example, encompasses the monitoring of new attachments and loadings for poles to be certain that the poles are sufficient to carry the new loadings, cyclical in-place inspection and restoration and replacement programs based on new loadings and the results of wood pole inspection, and emergency services. In-place wood pole inspection, as used herein, refers to a nondestructive or minimally-invasive inspection or nondestructive evaluation to determine strength loss in service of a highly variable material, wood, which has been processed, prior to installation, by treatment with wood preservatives to resist attack by wood-destroying organisms such as fungal decay and insects.

While the wood of wooden poles and other wooden structures are initially treated with oil- or water-borne preservatives that protect against both fungi and insects, the loss of these preservatives over time from the wood leaves the structures susceptible to decay from the gradual deterioration caused by fungi and other low forms of plant life (e.g., algae) as well as from infestation by insects including termites, ants, and wood borers. Depending on their geographical location, wooden poles in the United States are classified as being located in one of five “Decay Severity Zones” by the U.S. Department of Agriculture's Rural Utilities Service. Zone 1, where the humidity and temperature is the least conducive to fungal growth and insect infestation, encompasses much of the mountainous West of the United States, whereas Zone 5, the most severe area of decay, is made up of the hot and humid coasts of the southeastern states.

A planned in-place inspection program for wooden poles serves several functions: identifying those poles which present a danger or risk of failure so that those poles can be removed and replaced, identifying poles which are in early stages of damage or decay so that remedial treatments or reinforcement can be applied to those still-serviceable poles to extend their serviceable life, and collecting data and information for planning future inspection and maintenance actions for a system of wood poles. Proper inspection of wooden poles, depending upon the decay hazards in the area, can extend the serviceable life of those poles to 75-100 years.

Spot checking is the initial step in developing a planned pole inspection and maintenance program. Spot checking is a method of sampling representative groups of poles on a system to determine the extent of pole decay and to establish priority candidates for the pole maintenance measures of the program. A general recommendation is to inspect a 1,000-pole sample, made up of continuous pole line groupings of 50 to 100 poles in several areas of the system. The sample should be representative of the poles in place. For instance, all the poles on a line circuit or a map section should be inspected as a unit and not just the poles of a certain age group. Field data should be collected on the sample as to age, supplier, extent of decay, etc.

The data should be analyzed to determine the areas having the most severe decay conditions and to establish priorities for a pole-by-pole inspection of the entire system. It may be desirable to take additional samples on other portions or areas of the system to determine if the severity of decay is significantly different to warrant the establishment of an accelerated pole inspection and maintenance program for that portion of the system. The results of the spot check will aid in scheduling a continuous pole inspection and maintenance program at a rate commensurate with the incidence of decay.

The Rural Utilities Service suggests varying timing for a cyclical pole inspection schedule depending on the geographical Decay Zone in which the wooden poles are located, as the vulnerability of poles to decay is generally proportionate to the decay zone in which they are installed. Poles located in the low-decay Zone 1, for example, should be initially inspected within 12-15 years after installation, with subsequent re-inspection approximately 12 years, and with approximately 1 out of every 12 poles in the system being inspected as representatives of the entire system. In contrast, poles located in the high-decay Zones 4 and 5 should be initially examined within 8-10 years after installation, with subsequent re-inspection every 8 years, and with approximately 1 out of every 8 poles in the system being inspected as representatives of the entire system.

If a spot check indicates that decay is advanced in 1 percent of the pole sample, the inspection and maintenance program should be accelerated so that a higher percentage of poles are inspected and treated sooner than the suggested timelines discussed above. Conversely, if the decay rate is low for a particular decay zone or area in the system, the pole-by-pole inspection can be adjusted accordingly.

After an inspection of wooden poles has been completed, the inspection results are used to update pole plant records, evaluate pole conditions, plan future inspection and maintenance actions, and provide information for system map revisions. The inspection process will result in identifying the condition of each individual pole. The National Electric Safety Code (NESC) requires that if the strength of a structure deteriorates to the level of the overload capacity factors required at replacement, the structure must be replaced or rehabilitated. The inspection results should indicate if a pole is “serviceable” or a “reject.”

The NESC designates that a pole is considered “serviceable” when a large portion of completely sound wood exists, or only early stages of decay are present that have not reduced the pole strength below NESC requirements. A pole that does not meet these conditions should be classified as a “reject.” Examples of “reject” poles are those that have suffered decay, insect, mechanical, or woodpecker damage that has reduced the pole strength at the groundline below NESC requirements, or those with hazardous above-ground conditions such as a split top.

Rejected poles may be classified further depending on the severity of their deterioration and whether they are reinforceable. A “reinforceable reject” is a rejected pole which is suitable for restoration of its groundline bending capacity with an industry-accepted method of reinforcement. A “replacement” candidate is a rejected pole which is not suitable for necessary rehabilitation, and a “priority reject” is a rejected pole that has such severe decay/damage that it should be removed from service as quickly as possible.

Remedial treatments for serviceable wooden poles can interrupt the degradation of a structure by the addition of chemicals, such as pesticides, insecticides, and fungicides, which combat decay and extend the useful life of the structure. Remedial treatments include the application of external preservatives used for groundline treatment as well as internal treatments such as liquid internal preservatives, fumigants, and solids. Woodpecker damage can be repaired by plugging woodpecker holes with various materials and covering the plugged hole with a wire mesh to discourage further woodpecker attack. Reinforcement of a pole can be implemented by splinting or stubbing a pole using steel channel, reinforcing fiberglass, and epoxy.

### EXAMPLES

The following Examples are only illustrative. It will be readily seen by one of ordinary skill in the art that the present invention fulfills all of the objectives set forth above. After reading the foregoing specification, one of ordinary skill will be able to effect various changes, substitutions of equivalents, and various other aspects of the invention as broadly disclosed therein. It is therefore intended that the protection granted herein be limited only by the definition contained in the appended claims and equivalents thereof.

### Example 1

A device 100 for automatically profiling the density, and therefore the strength, of a wooden structure 110. The device 100 comprises a handle 102, a distance sensor 104, a shaft 106, and a capacitive sensor 108. The device 100 is operated by inserting the capacitive sensor 108 into a hole 112 bored into the wooden structure 110. The capacitive sensor 108 determines and records the dielectric behavior of the material of the structure 110 surrounding the sensor 108, and the distance sensor 104 determines and records the corresponding depth of the sensor 108 into the structure 110. These recorded values are then normalized and integrated to develop a profile of the dielectric constant of a cross-section of the wood of structure 110 to analyze the density and strength of the structure 110.

What is claimed is:

1. A device for evaluating the dielectric behavior of a structure, comprising:
a distance sensor;
a shaft; and
a capacitive sensor.

2. The device of claim 1, wherein the capacitive sensor is mounted to the shaft.

3. The device of claim 2, wherein the distance sensor is mounted on the shaft.

4. The device of claim 1, wherein the distance sensor is a short-range sonar.

5. The device of claim 1, wherein the device is a handheld device

6. The device of claim 5, wherein the distance sensor is mounted on a handle.

7. The device of claim 1, wherein the shaft is electrically non-conductive.

8. The device of claim 7, wherein the material is a polyester impregnated with fiberglass.

9. The device of claim 1, wherein the capacitive sensor is located on the tip of the shaft.

10. The device of claim 9, wherein the capacitive sensor has a diameter between ¼ and ½ inches and a length between ½ and 1 inches.

11. The device of claim 10, wherein the capacitive sensor comprises a capacitive sensor plate.

12. The device of claim 11, wherein the capacitive sensor plate comprises a concentric ring.

13. The device of claim 12, wherein the concentric ring is broken.

14. The device of claim 1, wherein the device is grounded by an operator of the device or the structure.

15. A method of assessing a structure comprising the steps of introducing a hole into said structure and introducing the capacitive sensor of the device of claim 1.

16. A method of assessing a structure comprising the steps of introducing a hole into said structure and introducing the capacitive sensor of the device of claim 14.

17. A method for evaluating the dielectric behavior of a structure, comprising the steps of:
inserting a capacitive sensor into a structure;
determining a location of the capacitive sensor in the structure with a distance sensor;
measuring the discharge rate of the capacitive sensor in said structure; and
moving the capacitive sensor deeper into the structure while continuing to determine the location within the structure and measuring the discharge rate of the capacitive sensor.

18. The method of claim 17, wherein the capacitive sensor and the distance sensor are components of a single device for evaluating the dielectric behavior of a structure.

19. The method of claim 17, wherein the structure comprises wood.

20. The method of claim 19, wherein the structure is selected from the group consisting of a utility pole, a piling, a beam, a board, and a timber.

21. The method of claim 19, wherein the discharge rate of the capacitive sensor indicates the dielectric behavior of the wood surrounding the capacitive sensor at a location within the structure.

22. The method of claim 21, wherein the dielectric behavior of the structure indicates the condition of the wood at a location within the structure.

23. The method of claim 21, further comprising the step of comparing the dielectric behavior of the wood surrounding the capacitive sensor at a location within the structure with the dielectric behavior of reference wood.

24. The method of claim 23, further comprising the step of determining whether the dielectric behavior of the wood surrounding the capacitive sensor is different than the dielectric behavior of a reference wood.

25. The method of claim 24, wherein normal wood is indicated when the dielectric behavior of the wood surrounding the capacitive sensor is essentially the same as the dielectric behavior of the reference wood.

26. The method of claim 24, wherein damaged or decayed wood is indicated when the dielectric behavior of the wood surrounding the capacitive sensor is different than the dielectric behavior of the reference wood.

27. The method of claim 21, wherein the wood surrounding the capacitive sensor comprises the wood within 50 millimeters of the capacitive sensor.

28. The method of claim 17, wherein the step of inserting the capacitive sensor into the structure comprises inserting the capacitive structure into a hole in the wooden structure.

29. The method of claim 28, wherein the hole in the wooden structure is bored by an operator of the capacitive sensor.

30. The method of claim 28, wherein the hole has a diameter of no greater than ½ inches.

31. A method of profiling the condition of a wood structure comprising the steps of:
determining the dielectric behavior of wood at a plurality of locations within the wood structure;
determining the location of each determined dielectric behavior within the wood structure; and
comparing the dielectric behavior at a plurality of locations within the wood structure to a dielectric behavior of a reference wood to prepare a profile of the condition of the wood structure.
